(19) United States
(12) Patent Application Publication
(10) Pub. No.: US 2024/0403099 A1
(43) Pub. Date: Dec. 5, 2024

(54) ESTIMATING END-USER PERFORMANCE OF CLOUD-BASED SERVICES

(71) Applicant: INTERNATIONAL BUSINESS MACHINES CORPORATION, ARMONK, NY (US)

(72) Inventors: Dinesh C. Verma, New Castle, NY (US); Mudhakar Srivatsa, White Plains, NY (US); Gerald Coon, Durham, NC (US); SATISHKUMAR SADAGOPAN, Leawood, KS (US); Utpal Mangla, Toronto (CA); Mathews Thomas, Flower Mound, TX (US)

(21) Appl. No.: 18/326,195

(22) Filed: May 31, 2023

(51) Int. Cl. G06F 9/455

(52) U.S. Cl. CPC G06F 9/45558; G06F 2009/4557; G06F 2009/45591

(57) ABSTRACT

An embodiment for improved estimating of end-user performance of cloud-based services. The embodiment may collect, for a target cloud-based service, a first dataset including network level metrics, and a second dataset including end-user performance data from one or more monitoring services. The embodiment may combine the collected first dataset and second dataset to generate a curated training dataset. The embodiment may train a machine learning prediction model using the curated training dataset. The embodiment may predict and estimate, using the trained machine learning prediction model, the end-user performance of the target cloud-based service for any target end-user.

### BACKGROUND

The present application relates generally to computer processing, and more particularly, to estimating end-user performance of cloud-based services.

Many businesses host a variety of cloud-based services or applications to meet the needs of the end users who make up their customers. To ensure end user and customer satisfaction, many of the businesses hosting cloud-based services or applications devote resources to investing in third party monitoring services that monitor end-user performance data of their cloud-based services or applications. Businesses may then seek to leverage this collected data to provide for an improved customer and end user experience for a given target cloud-based service or application by taking appropriate remedial actions for any observed shortcomings.

### SUMMARY

According to one embodiment, a method, computer system, and computer program product for improved estimating of end-user performance of cloud-based services is provided. The embodiment may include collecting, for a target cloud-based service, a first dataset including network level metrics, and a second dataset including end-user performance data from one or more monitoring services. The embodiment may also include combining the collected first dataset and second dataset to generate a curated training dataset. The embodiment may further include training a machine learning prediction model using the curated training dataset. The embodiment may further include predicting and estimating, using the trained machine learning prediction model, the end-user performance of the target cloud-based service for any target end-user.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an operational flowchart for an exemplary process of estimating end-user performance of cloud-based services according to at least one embodiment;

FIG. 3 illustrates exemplary system architecture of an illustrative data processing program capable of estimating end-user performance of cloud-based services according to at least one embodiment; and

FIG. 4 illustrates exemplary process of combining datasets to generate a curated training dataset for training of a prediction model that may be leveraged by an illustrative data processing program capable of estimating end-user performance of cloud-based services according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present application relate generally to computer processing, and more particularly, to improved estimating of end-user performance of cloud-based services. The following described exemplary embodiments provide a system, method, and program product to, among other things, collect, for a target cloud-based service, a first dataset including network level metrics, and a second dataset including end-user performance data from one or more monitoring services, combine the collected first dataset and second dataset to generate a curated training dataset, train a machine learning prediction model using the curated training dataset, and predict and estimate, using the trained machine learning prediction model, the end-user performance of the target cloud-based service for any target end-user. Therefore, the presently described embodiments have the capacity to improve estimating of end-user performance of cloud-based services by collecting data from both network level metrics as well as performance data from monitoring services to generate a curated training data set that may be used to train a machine learning prediction model such that it may predict end-user performance for a target cloud-based service for all users of the cloud-based service.

As previously described, many businesses host a variety of cloud-based services or applications to meet the needs of the end users who make up their customers. To ensure end user and customer satisfaction, many of the businesses hosting cloud-based services or applications devote resources to investing in third party monitoring services that monitor end-user performance data of their cloud-based services or applications. Businesses may then seek to leverage this collected data to provide for an improved customer and end user experience for a given target cloud-based service or application by taking appropriate remedial actions for any observed shortcomings.

However, business face many challenges in estimating end-user performance of their users for a target cloud-based service. For example, businesses often rely on third party monitoring sites which only provide data for a limited number of monitoring points and are unable to provide performance data for actual users. Furthermore, the cost to add additional monitoring points is often associated with significant, sometimes cost prohibitive, increases in costs for the services. Due to the limited number of monitoring points, estimates of end-user performance for a target cloud-based service may be inaccurate for any users that are accessing the service from a unique or distant location in comparison to the limited monitoring points. Also, while the third party monitoring service data is quite accurate for the small set of selected monitoring points, it does not provide or take into consideration network level metrics associated with the cloud-based service. Businesses would benefit from improved methods of estimating end-user performance for a target cloud-based service that are not overly reliant on limited data from a small set of monitoring points associated with a third party monitoring service.

Accordingly, a method, computer system, and computer program product for improved estimating of end-user performance of cloud-based services would be advantageous. The method, system, and computer program product may collect, for a target cloud-based service, a first dataset including network level metrics, and a second dataset including end-user performance data from one or more monitoring services. The method, system, computer program product may combine the collected first dataset and second dataset to generate a curated training dataset. The method, system, computer program product may then train a machine learning prediction model using the curated training dataset. Thereafter, the method, system, computer program product may predict and estimate, using the trained machine learning prediction model, the end-user performance of the target cloud-based service for any target end-user. In turn, the method, system, computer program product has provided for improved estimating of end-user performance of cloud-based services by collecting data from both network level metrics as well as performance data from monitoring services to generate a curated training data set that may be used to train a machine learning prediction model such that it may predict end-user performance for a target cloud-based service for all users of the cloud-based service. Presently described embodiments thus provide for a prediction model that leverages a more comprehensive set of data related to both the cloud-based service network level metrics and applicable end-user monitoring service data to better predict end-user performance for all users of the cloud-based service regardless of whether a given user is closely related to, or situated geographically near, the limited set of monitoring points selected by the third party monitoring service.

The present invention may be a system, a method, and/or a computer program product at any possible technical detail level of integration. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

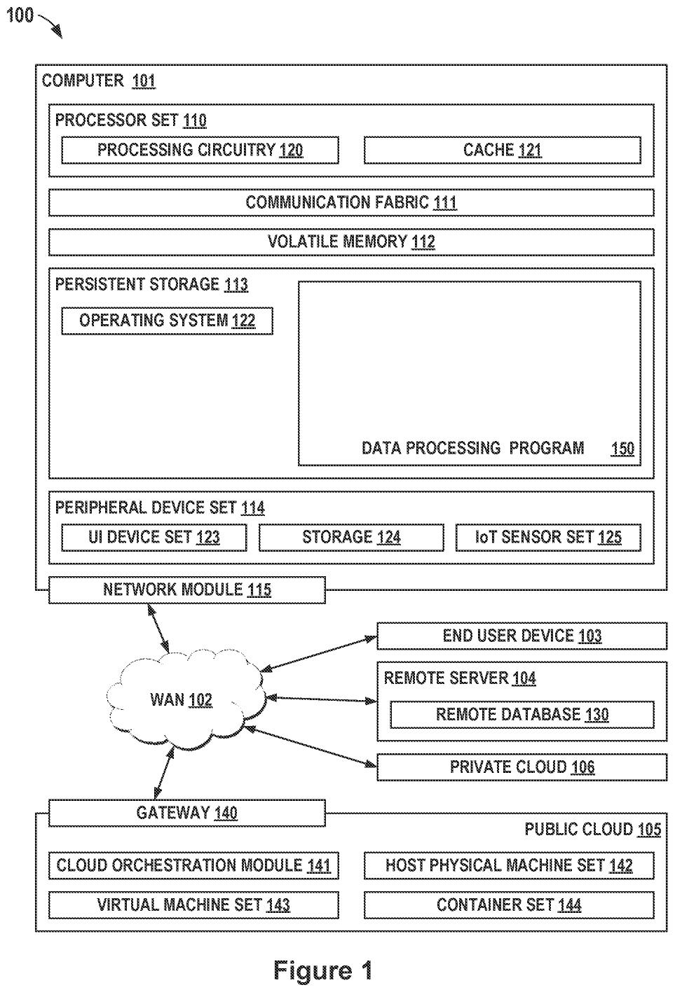

Referring now to FIG. 1, computing environment 100 contains an example of an environment for the execution of at least some of the computer code involved in performing the inventive methods, such as data processing program/code 150. In addition to data processing code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data processing code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in data processing code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in data processing 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the data processing program 150 may be a program capable of collecting, for a target cloud-based service, a first dataset including network level metrics, and a second dataset including end-user performance data from one or more monitoring services. Data processing program 150 may combine the collected first dataset and second dataset to generate a curated training dataset. Next, data processing program 150 may train a machine learning prediction model using the curated training dataset. Thereafter, data processing program 150 may predict and estimate, using the trained machine learning prediction model, the end-user performance of the target cloud-based service for any target end-user. In turn, data processing program 150 has provided for improved estimating of end-user performance of cloud-based services by collecting data from both network level metrics as well as performance data from monitoring services to generate a curated training data set that may be used to train a machine learning prediction model such that it may predict end-user performance for a target cloud-based service for all users of the cloud-based service. Presently described embodiments thus provide for a prediction model that leverages a more comprehensive set of data related to both the cloud-based service network level metrics and applicable end-user monitoring service data to better predict end-user performance for all users of the cloud-based service regardless of whether a given user is closely related to, or situated geographically near, the limited set of monitoring points selected by the third-party monitoring service.

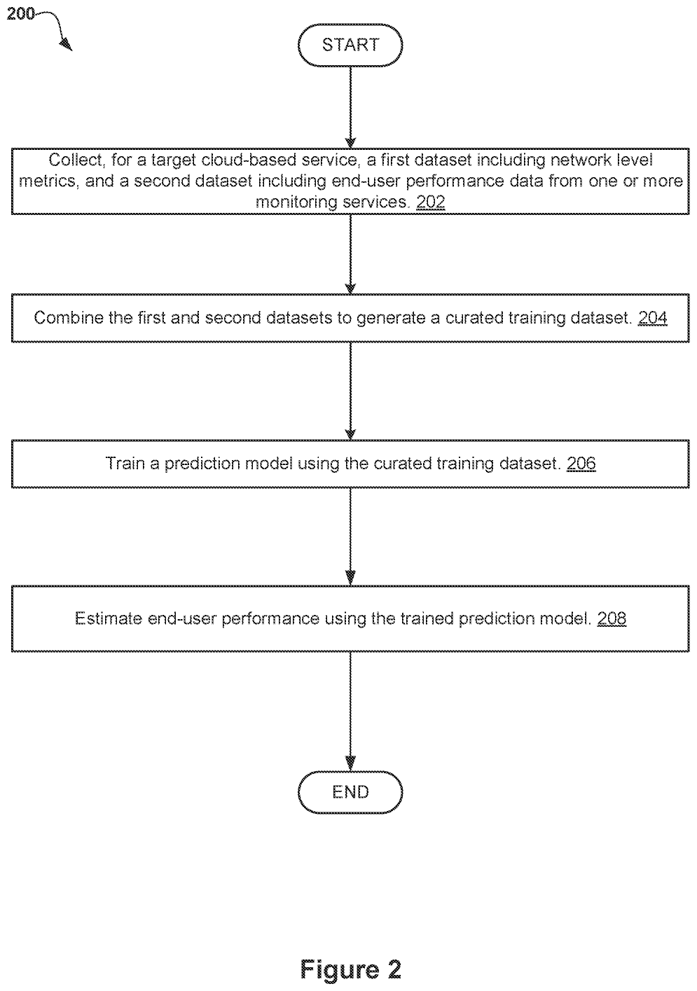

Referring now to FIG. 2, an operational flowchart for an exemplary process 200 of estimating end-user performance of cloud-based services according to at least one embodiment is provided.

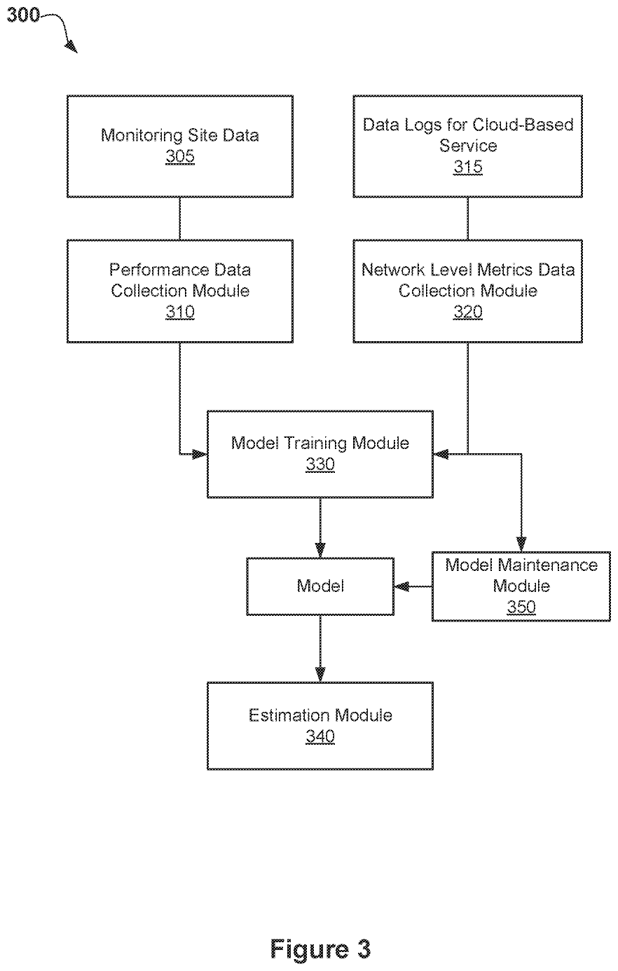

FIG. 3 illustrates exemplary system architecture of an illustrative data processing program 150 capable of estimating end-user performance of cloud-based services according to at least one embodiment. The exemplary system architecture 300 depicted in FIG. 3 includes a performance data collection module 310 configured to collect accessible monitoring site data 305, a network level metric data collection module 320 configured to collect network level metric data from accessible data logs 315 associated with a target cloud-based service, a model training module 330, a model 335, an estimation module 340, and a model maintenance module 350. Exemplary system architecture 300 will be referenced and described in greater detail throughout the description of illustrative process 200 below.

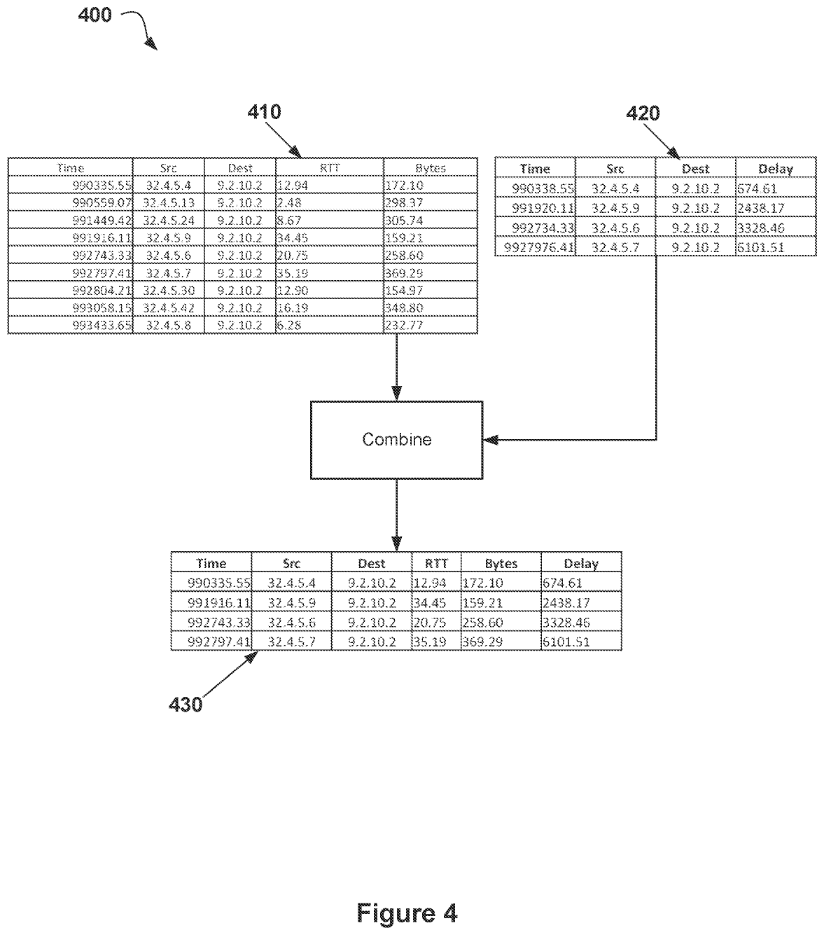

Returning to FIG. 2 and the illustrative process 200, at 202, data processing program 150 may collect, for a target cloud-based service, a first dataset including network level metrics, and a second dataset including end-user performance data from one or more monitoring services. In the context of this disclosure, a target cloud-based service may include any type of cloud storage services, software as a service (SaaS) application, infrastructure as a service (IaaS) services, platform as a service (PaaS) services, cloud-based backup services, content delivery networks (CDNs) services, virtual desktop infrastructure (VDI) services, or any other type of cloud-based software services. At this step, data processing program 150 may utilize an exemplary network level metric data collection module 320 configured to collect network level metric data from accessible data logs 315 associated with a target cloud-based service. In embodiments, network level metrics may include, for example, packets sent on a connection, packets received on a connection, bytes sent on a connection, bytes received on a connection, retransmitted bytes on a connection, lost bytes on a connection, round trip response time (RTT) on a connection, delays between connection establishment request and connection establishment response packet, among others. In embodiments, a time when the connection started or ended may also be recorded. In embodiments, a connection may be identified by means of the source and destination network address, the source and destination ports, and the protocol used, alternatively referred to as the 5-tuple. In addition to the 5-tuple, some embodiments may define connections on the basis of the underlying protocol, such as the individual sessions within an encrypted communication, an individual network time synchronization transaction using the network time protocol etc. In some embodiments, data processing program 150 may calculate a connection identifier as a part of the collection of network metrics. In embodiments, when matching the connections from the network metrics and the response time, the matching connections may be identified using the 5-tuples, connection identifier, and the starting time or ending time of the connection. In embodiments, to allow for the variation in clock measurements, time comparisons may be offset to include a multiple of round-trip latency between the monitoring site and the server to determine if connections stated and were monitored at the same time. In embodiments, the network level metrics may further include, for example, background information related to a recorded user interaction that has been recorded in the accessible data log, such as the source of the user, connection time of the user, destination, other background server information, or any other useful information related to identifying information related to a given user or associated servers or networks being used. An illustrative table 410 representing a portion of an exemplary first dataset that may be collected by utilize an exemplary network level metric data collection module 320 of an exemplary data processing program 150 at step 202 is shown in FIG. 4.

The second dataset collected by data processing program 150 at step 202 includes end-user performance data from one or more monitoring services. As discussed above, monitoring services typically utilize a set number of monitoring points (or sites) to obtain precise end-user performance data for each individual monitoring point. In embodiments, end-user performance data from one or more monitoring services may include data related to the response time observed at the cloud-based service, the time taken to download a given file, the latency between a request and when the entire response is rendered, the lag at which a movie can be played, the maximum, minimum or average amount of buffer that is occupied, the choppiness of an audio clip, among other examples. The end performance metrics may be measured in units of time (seconds/milliseconds etc.), units of storage (bytes/megabytes etc.), or in any other suitable units of measure or indicator (e.g. variations in amount of data received per unit time, jitteriness of delays, or an assessment of quality of sound or video received at the monitoring point). In other embodiments, end-user performance data from a given monitoring service may include, for example, the delay in loading a page, delay in downloading a given file, time to receive a first response back after a request has been received, time to render an image, delay time between a user sending a request and then being able to take a subsequent follow-up action, and any other delay or time measurements that may be associated with a given user action. The end-user performance data is thus dependent upon the target cloud-based service and corresponding actions that may be taken by a user. The performance data associated with the corresponding actions is what may be measured by the one or more monitoring services. To collect the second dataset, data processing program 150 may utilize an exemplary performance data collection module 310 configured to collect accessible monitoring site data 305. An illustrative table 420 representing a portion of an exemplary second dataset that may be collected by an exemplary an exemplary performance data collection module 310 of data processing program 150 is shown in FIG. 4. It should be noted that the limited number of end-user performance data entries within the collected second dataset typically will typically be associated with certain corresponding rows or entries in the collected first dataset including the network level metrics for the associated cloud-based service.

Next, at 204, data processing program 150 may combine the collected first dataset and second dataset to generate a curated training dataset. FIG. 4 illustrates exemplary process 400 of combining datasets to generate a curated training dataset for training of a prediction model that may be leveraged by an illustrative data processing program 150 capable of estimating end-user performance of cloud-based services according to at least one embodiment. In embodiments, for example, a model training module 330 of data processing program 150 may be configured to combine a first dataset including network level metric data represented by a table 410 with a second dataset including end-user performance data from one or more monitoring sites represented by a table 420 to generate a curated training dataset represented by another table 430. In embodiments, for example, the exemplary first dataset may include features represented as ‘x1 . . . xn’, extracted from the network level metrics associated with the target cloud-based service that may functionally serve as features for training a machine learning model for predicting end-user performance, while the second dataset may include performance values, represented as ‘y’ extracted from the performance monitoring sites data associated with the target cloud-based service that may functionally serve as labels for training a machine learning model for predicting end-user performance.

At 206, data processing program 150 may then train a machine learning prediction model using the curated training dataset. For example, at this step data processing program 150 may be configured to leverage an exemplary formula for a model to be fit represented by the following formula (where ‘Delay’ represents delay experienced by an end-user during an interaction, ‘RTT’ represents round trip time for bytes sent between a user and the server of the applicable cloud-based service, and ‘Bytes’ represents bytes sent during an action):

Delay=a(RTT*Bytes)+b

Accordingly, a model for predicting end-user performance for a target cloud-based service is obtained that leverages data from both the network level metrics for the cloud-based service, as well as the end-user performance data from associated monitoring service data based on a set of monitoring sites/points. In the exemplary formula above, the end-user performance for any given end user is represented as a delay value which may be predicted by the newly trained exemplary model ‘M1’ based on round-trip time and bytes. In embodiments, exemplary trained prediction models that are trained using curated training datasets generated by data processing program 150 may be configured to determine y=f(x1 . . . xn) for any given user of the target cloud-based service where y=end-user performance and x1 . . . xn represents network level metrics observable at the cloud side of the target cloud-based service, for example, in the connection logs for a given cloud-based service.

In embodiments, the model trained by data processing program 150 for predicting end-user performance for a target cloud-based service may be based on fitting the model based on a mathematical relationship as shown above, or it may be based on use of a machine learning or Artificial intelligence model to predict the output metric. Some example of suitable machine learning or Artificial Intelligence models may include, for example, neural networks, decision trees, support vector machines, regression models, correlation models, transformer networks among others.

Thereafter, at 208, data processing program 150 may predict and estimate, using the trained machine learning prediction model, the end-user performance of the target cloud-based service for any target end-user. Returning to the example above, at this step, data processing program 150 may be configured to utilize an exemplary estimation module 340 to leverage the trained prediction model from step 206 to estimate the end-user performance for any user of the target cloud-based service. For example, data processing program 150 may leverage the exemplary trained model ‘M1’ discussed in the example above to estimate end-user performance for an exemplary user ‘U1’. Exemplary data processing program 150 may output end-user performance estimates using any desired metric, such as, for example, estimated delays experienced by the user, more specifically, the delay in loading a page, delay in downloading a given file, time to receive a first response back after a request has been received, time to render an image, delay time between a user sending a request and then being able to take a subsequent follow-up action, and any other delay or time measurements that may be associated with a given user action. The estimation made by data processing program 150 at 208 may be a numeric value, or it may be as a category (good service/mediocre service/bad service).

In embodiments, data processing program 150 may further be configured to ensure that the trained prediction model is continuously monitored and updated to prevent performance drift in the presence of dynamic network conditions over time. For example, in embodiments, data processing program 150 may further include a model maintenance 350 configured to continuously collect the metrics being monitored (network level metrics and performance data from monitoring sites) at periodic intervals (epochs), validate that the trained prediction model formula of y=f(x1 . . . xn) from epoch n holds for epoch n+1 (where y=performance and x1 . . . xn represents network level metrics inputs) to detect any deviations or performance drift, and then, in the case of deviation or performance drift, retrain the trained prediction model using data from the latest interval or epoch. In embodiments, it may be assumed that the trained prediction model based on a given monitoring site is valid for all other sites. In other embodiments, it is envisioned that data processing program 150 may be utilized to train multiple prediction models in environments in which some monitoring sites are experiencing different congestion points in the network. In this instance and embodiments, data processing program 150 may be configured to further estimate if there is a shared delay by means of correlation of cloud-side metrics, and subsequently clustering correlated users and calculating the model and use for the clusters of users. For example, in one embodiment, data processing program 150 may leverage the same AI model for all connections. In an alternative embodiment, data processing program 150 may leverage different models for different connections. As an example, connections may be grouped on the basis of the network addresses of the users, or on the basis of the geography from which the user connections originates. For example, one model may be used for all connections originating in Europe, a second model for all connections originating in Americas, and a third model for all connections originating in Asia. Connections can also be grouped into similar categories by running algorithms to find those with similar network metrics into a common cluster. Such clustering algorithms include k-means clustering, density-based clustering, gaussian mixture models, centroid calculation algorithms etc.

It may be appreciated that data processing program 150 has thus provided for improved estimating of end-user performance of cloud-based services by collecting data from both network level metrics as well as performance data from monitoring services to generate a curated training data set that may be used to train a machine learning prediction model such that it may predict end-user performance for a target cloud-based service for all users of the cloud-based service. Presently described embodiments thus provide for a prediction model that leverages a more comprehensive set of data related to both the cloud-based service network level metrics and applicable end-user monitoring service data to better predict end-user performance for all users of the cloud-based service regardless of whether a given user is closely related to, or situated geographically near, the limited set of monitoring points selected by the third-party monitoring service.

It may be appreciated that FIG. 2 provides only illustrations of an exemplary implementation and does not imply any limitations with regard to how different embodiments may be implemented. Many modifications to the depicted environment may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of estimating end-user performance of cloud-based services comprising:
collecting, for a target cloud-based service, a first dataset including network level metrics, and a second dataset including end-user performance data from one or more monitoring services;
combining the collected first dataset and the second dataset to generate a curated training dataset;
training a machine learning prediction model using the curated training dataset; and
predicting and estimating, using the trained machine learning prediction model, the end-user performance of the target cloud-based service for any target end-user.

2. The computer-based method of claim 1, wherein the end-user performance data from the one or more monitoring services is derived from a set of monitoring points.

3. The computer-based method of claim 1, further comprising:
continuously collecting the network level metrics and the end-user performance data form one or more monitoring services at periodic intervals; and
continuously validating the trained prediction model at the period intervals to detect any deviations or performance drift.

4. The computer-based method of claim 3, further comprising:
in response to detecting the deviations or performance drift, automatically retraining the trained prediction model using data from a latest interval.

5. The computer-based method of claim 1, wherein the target cloud-based service comprises one or more a cloud storage service, a software as a service application, an infrastructure as a service service, a platform as a service service, a cloud-based backup services, a content delivery network services, and a virtual desktop infrastructure service.

6. The computer-based method of claim 1, wherein the network level metrics comprise at least one of bytes sent, bytes received, bytes retransmitted, error messages received, flow control data, bytes exchanged, network round trip time (RTT), and network latency.

7. The computer-based method of claim 1, wherein the estimated end-user performance for each of the end users of the target cloud-based service comprises an estimated measurement of delay experienced by the end users.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
collecting, for a target cloud-based service, a first dataset including network level metrics, and a second dataset including end-user performance data from one or more monitoring services;
combining the collected first dataset and the second dataset to generate a curated training dataset;
training a machine learning prediction model using the curated training dataset; and
predicting and estimating, using the trained machine learning prediction model, the end-user performance of the target cloud-based service for any target end-user.

9. The computer system of claim 8, wherein the end-user performance data from the one or more monitoring services is derived from a set of monitoring points.

10. The computer system of claim 8, further comprising:
continuously collecting the network level metrics and the end-user performance data form one or more monitoring services at periodic intervals; and
continuously validating the trained prediction model at the period intervals to detect any deviations or performance drift.

11. The computer system of claim 10, further comprising:
in response to detecting the deviations or performance drift, automatically retraining the trained prediction model using data from a latest interval.

12. The computer system of claim 8, wherein the target cloud-based service comprises one or more a cloud storage service, a software as a service application, an infrastructure as a service service, a platform as a service service, a cloud-based backup services, a content delivery network services, and a virtual desktop infrastructure service.

13. The computer system of claim 8, wherein the network level metrics comprise at least one of bytes sent, bytes received, bytes retransmitted, error messages received, flow control data, bytes exchanged, network round trip time (RTT), and network latency.

14. The computer system of claim 8, wherein the estimated end-user performance for each of the end users of the target cloud-based service comprises an estimated measurement of delay experienced by the end users.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
collecting, for a target cloud-based service, a first dataset including network level metrics, and a second dataset including end-user performance data from one or more monitoring services;
combining the collected first dataset and the second dataset to generate a curated training dataset;
training a machine learning prediction model using the curated training dataset; and
predicting and estimating, using the trained machine learning prediction model, the end-user performance of the target cloud-based service for any target end-user.

16. The computer program product of claim 15, wherein the end-user performance data from the one or more monitoring services is derived from a set of monitoring points.

17. The computer program product of claim 15, further comprising:
continuously collecting the network level metrics and the end-user performance data form one or more monitoring services at periodic intervals; and
continuously validating the trained prediction model at the period intervals to detect any deviations or performance drift.

18. The computer program product of claim 17, further comprising:
in response to detecting the deviations or performance drift, automatically retraining the trained prediction model using data from a latest interval.

19. The computer program product of claim 15, wherein the network level metrics comprise at least one of bytes sent, bytes received, bytes retransmitted, error messages received, flow control data, bytes exchanged, network round trip time (RTT), and network latency.

20. The computer program product of claim 15, wherein the estimated end-user performance for each of the end users of the target cloud-based service comprises an estimated measurement of delay experienced by the end users.
